(19) United States
(12) Patent Application Publication
(10) Pub. No.: US 2025/0052716 A1
(43) Pub. Date: Feb. 13, 2025

(54) ELECTROPHORESIS DEVICE

(71) Applicant: Hitachi High-Tech Corporation, Tokyo (JP)

(72) Inventors: Katsunari MARUOKA, Tokyo (JP); Takeshi OOURA, Tokyo (JP); Katsuhiro ARITOME, Tokyo (JP)

(21) Appl. No.: 18/715,810

(22) PCT Filed: Dec. 15, 2021
(86) PCT No.: PCT/JP2021/046265

§ 371 Date: Jun. 3, 2024

(51) Int. Cl. G01N 27/447

(52) U.S. Cl. CPC G01N 27/44704

(57) ABSTRACT

An object of the present invention is to provide an electrophoresis device with high workability while protecting a detection unit at the time of a replacement work of a capillary array. The present invention is the electrophoresis device including the capillary array that includes one piece or more capillary, the capillary array including a load header arranged at one end, a capillary head arranged at the other end, and the detection unit formed between the load header and the capillary head and detecting a sample electrophoresed within the capillary. The electrophoresis device includes: a holder to which the detection unit is fit; and a protection unit protruding with respect to an array surface of the capillary array. When the detection unit is to be fit, the protection unit allows an inner surface of the holder to depart from the detection unit.

### TECHNICAL FIELD

This invention relates to an electrophoresis device.

### BACKGROUND ART

A capillary array used for a capillary electrophoresis device is replaced by a different one by a user when a measurement method is changed. However, since the capillary array was liable to hang down by a weight of a detection unit or an array head, it was possible that the detection unit came in contact with the device and was damaged at the time of a replacement work. Therefore, in Patent Literature 1, there is disclosed that, in order to facilitate replacement work of the capillary array, a retainer for retaining the capillary is arranged, and this retainer is configured of a slide portion and a plate portion (claim 5).

### CITATION LIST

Patent Literature1: WO2020/50193

### SUMMARY OF INVENTION

### Technical Problem

According to the electrophoresis device disclosed in Patent Literature 1, in order to prevent contact of the detection unit of the capillary array to the array holder, the plate should be slid while keeping the distance of the both, and workability for a user was never high.

An object of the present invention is to provide an electrophoresis device with high workability while protecting a detection unit at the time of a replacement work of a capillary array.

### Solution to Problem

To solve the above-described problem, the present invention is an electrophoresis device including a capillary array that includes one piece or more capillary, the capillary array including a load header arranged at one end, a capillary head arranged at the other end, and a detection unit formed between the load header and the capillary head and detecting a sample electrophoresed within the capillary. The electrophoresis device includes: a holder to which the detection unit is fit; and a protection unit protruding with respect to an array surface of the capillary array. When the detection unit is to be fit, the protection unit allows an inner surface of the holder to depart from the detection unit.

### Advantageous Effects of Invention

According to the present invention, it is possible to provide an electrophoresis device with high workability while protecting a detection unit at the time of a replacement work of a capillary array.

### BRIEF DESCRIPTION OF DRAWINGS

FIG. 1 is a schematic drawing of an electrophoresis device related to an embodiment of the present invention.

FIG. 2 is a drawing illustrating a configuration of a capillary array unit related to a first embodiment.

FIG. 3A is a drawing illustrating the capillary array unit of a state before being fit to a block of the electrophoresis device.

FIG. 3B is a drawing illustrating the capillary array unit of a state after being fit to the block of the electrophoresis device.

FIG. 4 is an exploded perspective view illustrating a configuration of a detection unit.

FIG. 5A is a plan view illustrating a configuration of a plate and a capillary array around the detection unit.

FIG. 5B is a cross-sectional view illustrating a configuration of the plate and the capillary array around the detection unit.

FIG. 6 is a drawing illustrating detail of a construction of an array holder.

FIG. 7A is a cross-sectional view illustrating a positional relation before the plate is slid with respect to the array holder in the first embodiment.

FIG. 7B is a cross-sectional view illustrating a positional relation after the plate is slid with respect to the array holder in the first embodiment.

FIG. 8A is a cross-sectional view illustrating a positional relation before the plate is slid with respect to the array holder in a second embodiment.

FIG. 8B is a cross-sectional view illustrating a positional relation after the plate is slid with respect to the array holder in the second embodiment.

FIG. 9 is a drawing illustrating a configuration of a capillary array unit in an electrophoresis device related to a third embodiment.

### DESCRIPTION OF EMBODIMENTS

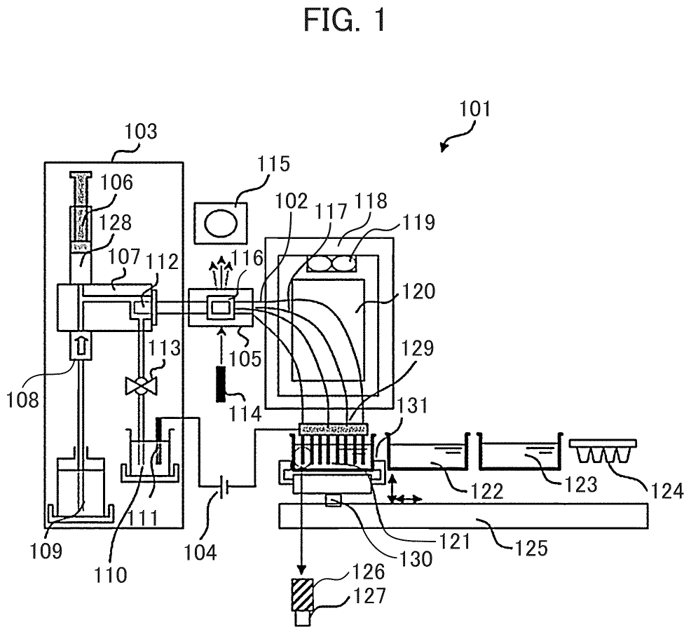

A configuration of an electrophoresis device 101 according to the embodiment of the present invention will be described using FIG. 1. As illustrated in FIG. 1, an electrophoresis device 101 includes a capillary array 117 configured of one piece or more of a capillary 102, a thermostatic chamber 118 keeping the capillary 102 at a constant temperature, a high voltage power supply 104 applying voltage to the capillary 102, a pump mechanism 103 pouring a polymer into the capillary 102, and a transportation mechanism 125. Also, the transportation mechanism 125 is a mechanism for transporting a buffer container 121, a cleaning container 122, a waste liquid container 123, and a sample container 124 to a capillary negative electrode end 127.

The capillary array 117 includes a load header 129 arranged at one end, a capillary head 112 arranged at the other end, and a detection unit formed between the load header 129 and the capillary head 112 and detecting a sample electrophoresed within the capillary 102. Also, the capillary array 117 is configured of the capillaries 102 of 8 pieces or 24 pieces for example, and is replaced by one having a different capillary length when the measurement method is changed. Further, also in a case a damage or deterioration of the property is seen in the capillary 102, the capillary array 117 is replaced by new one.

The capillary 102 is formed of a glass pipe with 50 μm inside diameter and 320 μm outside diameter, and the surface is coated with polyimide in order to improve the strength. However, out of the capillary 102, with respect to the detection unit 116 where a laser light is irradiated, polyimide coating is removed so that the light emitted from the inside is easily leaked to the outside. The inside of the capillary 102 is filled with a separation medium by the pump mechanism 103, the separation medium being for imparting the migration difference at the time of electrophoresis. According to the present embodiment, a polymer which is a high-viscosity solution is used as the separation medium.

The capillary negative electrode end 127 is fixed respectively through a hollow electrode 126 made of metal, and is in such state that the distal end of the capillary 102 extrudes from the hollow electrode 126 by approximately 0.5 mm. Also, all of the hollow electrodes 126 furnished for each of the capillary 102 are fit to the load header 129 in an integrated manner. Further, all of the hollow electrodes 126 are electrically connected to the high voltage power supply 104 mounted on the device body, and act as a negative electrode when voltage is applied such as the time of electrophoresis and sample introduction.

The capillary end portions on the opposite side of the capillary negative electrode end 127 are bundled to one by the capillary head 112 and are bonded. The capillary head 112 is connected to a block 107 with pressure resistance and airtightness. Also, the inside of the capillary 102 is filled with new polymer by the pump mechanism 103. The polymer is refilled to the inside of the capillary 102 at every measurement in order to improve the performance of the measurement.

An optical detection portion is configured of a light source 114 irradiating the detection unit 116, an array holder 105 holding the detection unit 116, and an optical detector 115 detecting light emission of the inside of the detection unit 116. When the sample within the capillary 102 separated by electrophoresis is to be detected, the detection unit 116 is irradiated by the light source 114, and light emission from the detection unit 116 is detected by the optical detector 115.

The thermostatic chamber 118 is covered by heat insulation material, and the inside thereof is controlled to a constant temperature by a heating and cooling mechanism 120. Also, a fan 119 circulates and stirs the air inside the thermostatic chamber 118 to keep the temperature of the capillary array 117 even and constant.

The pump mechanism 103 is configured of a plunger pump 106, the block 107, a check valve 108, an electrically operated valve 113, a polymer container 109, and a positive electrode buffer container 110. In the block 107, there is arranged a flow passage that allows the plunger pump 106, the polymer container 109, the positive electrode buffer container 110, and the capillary array 117 to communicate with each other. In a flow passage between the plunger pump 106 and the polymer container 109, there is arranged the check valve 108 that prevents the back current of the polymer. In a flow passage between the block 107 and the positive electrode buffer container 110, the electrically operated valve 113 is arranged. At the time of filling the polymer to a chamber 128 of the plunger pump 106 and the capillary array 117, the buffer solution is prevented from flowing in from the positive electrode buffer container 110 by closure of the electrically operated valve 113. When electrophoresis is to be executed, the electrically operated valve 113 opens, and a positive electrode 111 and the capillary negative electrode end 127 are energized.

The transportation mechanism 125 includes three electric motors and linear actuators not illustrated, and can move in three axis directions of up and down, left and right, and front and back. Also, on a moving stage 130 of the transportation mechanism 125, one piece or more containers can be mounted. Also, an electrically operated grip 131 is provided in the moving stage 130, and can grip and release each container. Therefore, the buffer container 121, the cleaning container 122, the waste liquid container 123, and the sample container 124 can be transported to the load header 129 according to the necessity. Also, a container not required is stored in a predetermined storage location within the device.

### First Embodiment

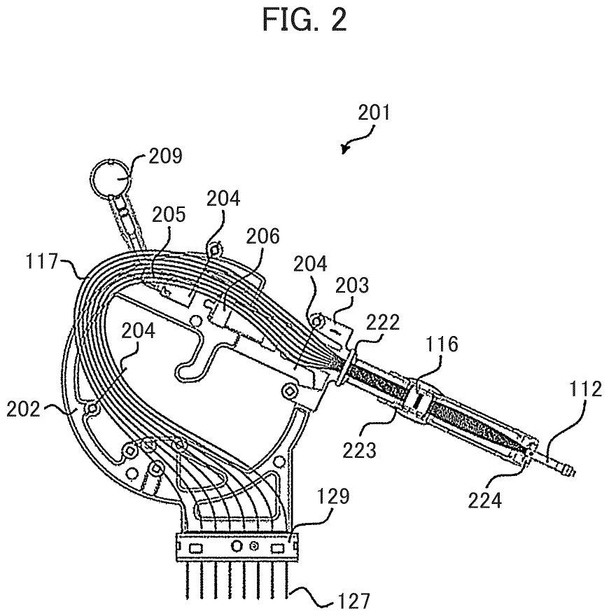

FIG. 2 is a drawing illustrating a configuration of a capillary array unit 201 related to the first embodiment. As illustrated in FIG. 2, the capillary array unit 201 of the present embodiment includes the capillary array 117, a frame 202, and a plate 203 sliding relatively to the frame 202. Each capillary 102 is held into a constant shape so as not to be entwined with each other by a separator 204 arranged in the frame 202. Also, the detection unit 116 and the capillary head 112 of the capillary array 117 are supported to the plate 203 by a detection unit support portion 223 and an array head support portion 224 of the plate 203 so as not to hang down by the own weight. Also, with respect to each capillary 102 attached to the plate 203, the capillary array is bundled by a bundle arm 222.

Also, a wireless managing tag 209 is attached to the frame 202, and the product serial number, the manufacturing date, the number of uses (number of times of executing electrophoresis), and the like of the capillary array unit 201 are recorded. Reading and rewriting of information recorded in the wireless managing tag 209 are executed through a communication unit arranged in the electrophoresis device.

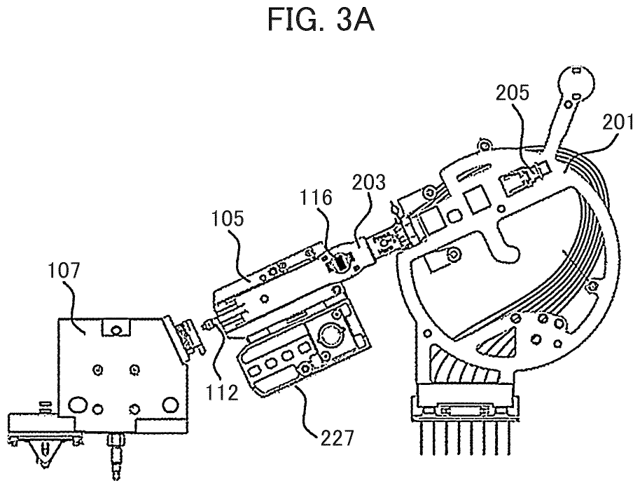

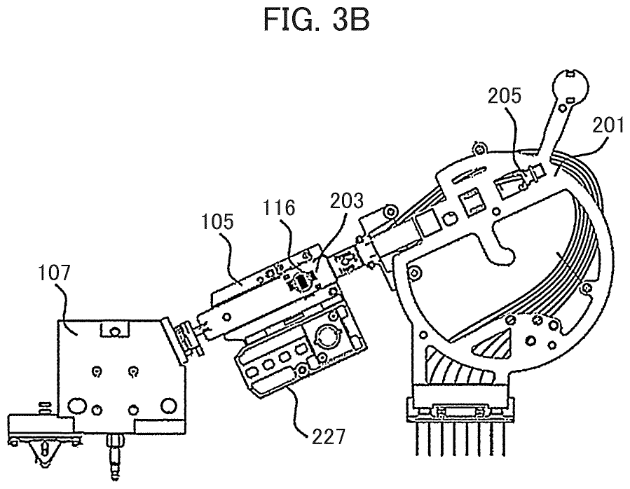

FIG. 3A is a drawing illustrating the capillary array unit 201 of a state before being fit to the block 107 of the electrophoresis device, and FIG. 3B is a drawing illustrating the capillary array unit 201 of a state after being fit to the block 107 of the electrophoresis device.

Immediately after inserting the capillary array unit 201 to the array holder 105, as illustrated in FIG. 3A, the plate 203 is fixed to the frame 202 by a fixing unit 205, and the capillary head 112 is not fit to the block 107. Next, when the plate 203 is detached from the fixing unit 205 and is slid toward the block 107, as illustrated in FIG. 3B, the capillary head 112 is inserted to the block 107, and the detection unit 116 is fit into a predetermined fitting position of the array holder 105.

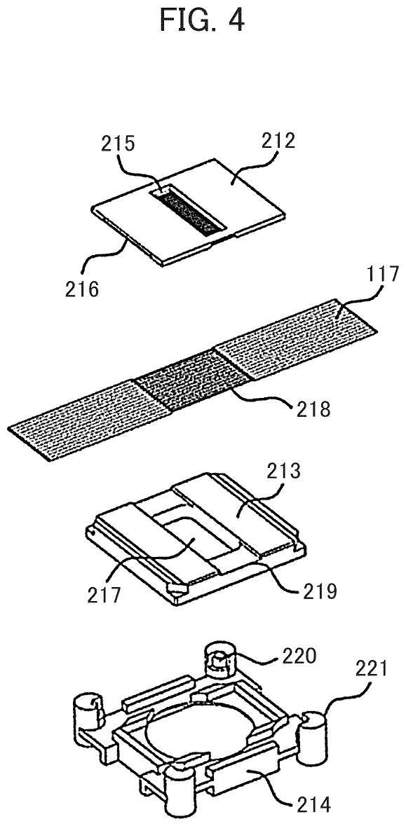

Here, the detail of the configuration of the detection unit 116 will be explained. FIG. 4 is an exploded perspective view illustrating a configuration of the detection unit 116. As illustrated in FIG. 4, the detection unit 116 is configured to combine, in order from the surface side, a silicon substrate 212, a polyimide coating removal portion 218 of the capillary array 117, a ceramics substrate 213, and a detection unit base 214. The silicon substrate 212 includes a first window 215 for taking out fluorescence, and a V groove 216 for arraying the capillary array 117. The ceramics substrate 213 includes a second window 217 for reducing the noise caused by reflection of the fluorescence, and a measurement window 219 for irradiating a laser light to the polyimide coating removal portion 218. Also, the silicon substrate 212, the capillary array 117, and the ceramics substrate 213 are laminated and are fixed thereafter by an adhesive agent.

The detection unit base 214 is configured of a resin, and includes, in the periphery, plural base convex portions 221 (protection portions) extending perpendicularly to the arraying surface of the capillary array. Also, in the base convex portion 221, a recess portion 220 is formed at a position opposing the corner portion of the ceramic substrate 213, the corner portion of the ceramics substrate 213 is fit into the recess portion 220, and thereby the ceramics substrate 213 and the like are positioned with respect to the detection unit base 214. Also, the base convex portion 221 not only protects the corner portion of the ceramic substrate 213, but also prevents other device components from coming contact with the silicon substrate 212 as described below.

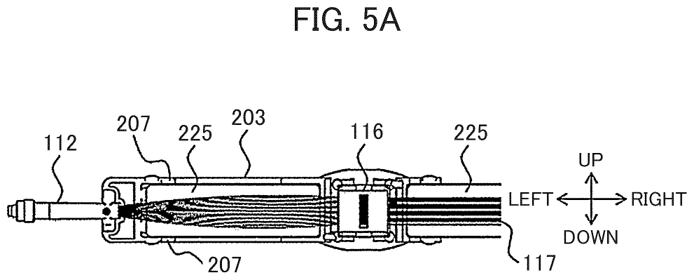

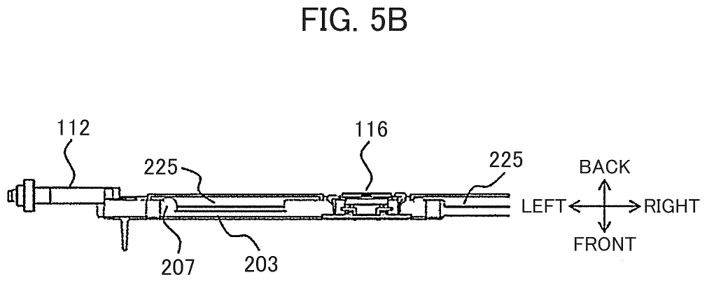

Next, a configuration of the plate 203 supporting the detection unit 116 and the capillary head 112 will be explained. FIG. 5A is a plan view illustrating a configuration of the plate 203 and the capillary array 117 around the detection unit 116, and illustrates the back side of the plate 203 and the like when the state of FIG. 3A is made “the front side”. FIG. 5B is a cross-sectional view illustrating a configuration of the plate 203 and the capillary array 117 around the detection unit 116, and illustrates a state of the plate 203 and the like as seen from the vertical direction.

As illustrated in FIG. 5A, a plate side heat conduction sheet 225 is arranged on the back side of the plate 203, and the capillary array 117 is arranged on the back surface side of the plate side heat conduction sheet 225. The plate side heat conduction sheet 225 is for suppressing excessive temperature rise of the capillary by conducting the heat generated by the capillary in applying high voltage. Further, the plate side heat conduction sheet 225 also exerts a role of preventing external light from entering the detection unit 116 by sealing the periphery of the capillary array 117 when an array holder cover 227 is closed. Therefore, the plate side heat conduction sheet 225 is preferable to be of a raw material having heat conductivity, insulation performance, and flexibility, and can use heat conduction rubber for example.

Also, the plate 203 includes plate convex portions 207 (protection portion) extending perpendicularly to the array surface of the capillary array 117 and protrude on the capillary head 112 side out of the edge portions positioned above and below the plate side heat conduction sheet 225. This plate convex portion 207 abuts on a holder rail 208 arranged on the array holder 105 side.

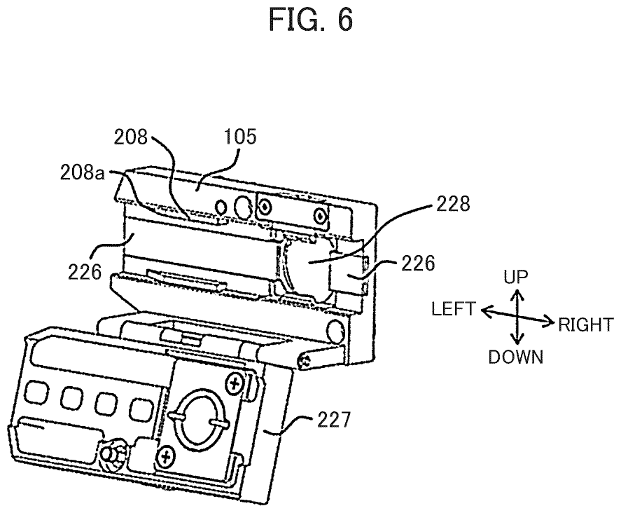

FIG. 6 is a drawing illustrating the detail of the construction of the array holder 105, and illustrates a state the array holder cover 227 opens. As illustrated in FIG. 6, the array holder 105 includes a holder side heat conduction sheet 226 arranged on the contact surface with the capillary array 117, the holder rails 208 arranged so as to oppose vertically sandwiching this holder side heat conduction sheet 226 and extending in the left and right direction, and the array holder cover 227 covering the front side. Further, in the array holder 105, there is also formed a window portion 228 allowing the detection unit 116 of the capillary array 117 to be exposed.

Similarly to the plate side heat conduction sheet 225 arranged in the plate 203, the holder side heat conduction sheet 226 is for preventing external light from entering the detection unit 116 while suppressing excessive temperature rise of the capillary, and is formed of heat conduction rubber and the like. The holder rail 208 abuts on the plate convex portion 207, and the slide direction dead end portion of the holder rail 208 includes a slope portion 208a.

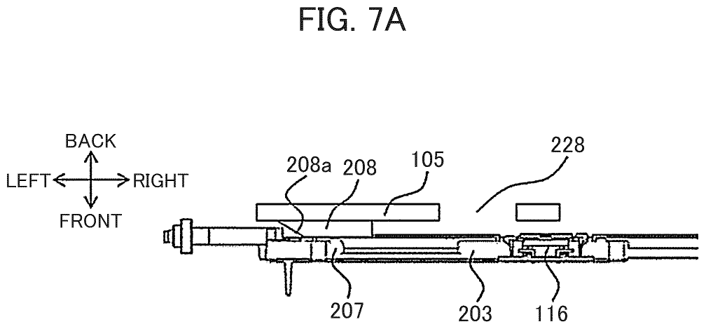

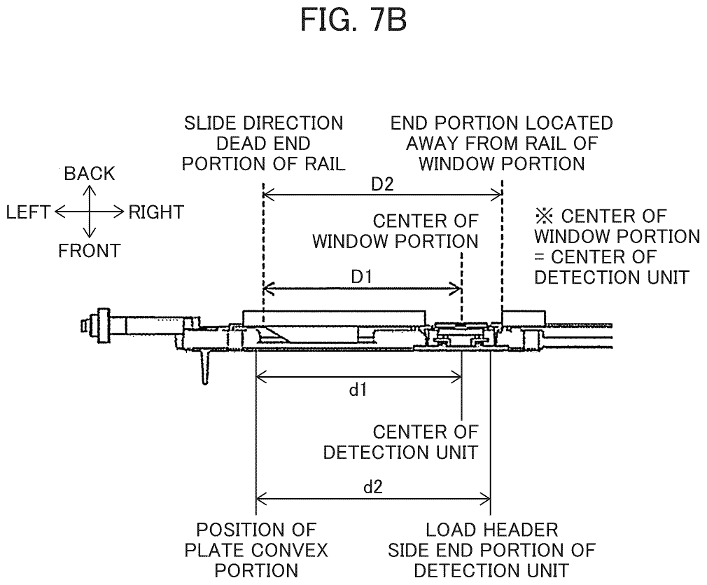

Next, the positional relation of the array holder 105 and the plate 203 will be explained using FIG. 7A and FIG. 7B. FIG. 7A is a cross-sectional view illustrating the positional relation before the plate 203 is slid with respect to the array holder 105 in the first embodiment, and FIG. 7B is a cross-sectional view illustrating the positional relation after the plate 203 is slid with respect to the array holder 105 in the first embodiment. Also, since FIG. 7A and FIG. 7B illustrate a state of the plate 203 and the array holder 105 as seen from the vertical direction in a state of opening the array holder cover 227, the array holder cover 227 is not illustrated. The array holder 105 is attached to a unit case 229, and there is arranged a step 231 in the unit case 229, the step 231 being for keeping the detection unit 116 and a condenser lens 230 at a predetermined distance.

Functions achieved commonly to the first, second, and third embodiments are that, before or during sliding of the plate 203, the detection unit 116 and the array holder 105 are not allowed to come in contact with each other, the distance is secured, and thereby contamination and damage of the detection unit 116 are prevented, and after the plate 203 is slid, the detection unit 116 is disposed at the position of the window portion 228, the detection unit 116 and the step 231 are allowed to come in contact with each other, thereby the distance between the detection unit 116 and the condenser lens 230 is kept constant, and highly precise positioning optically required is executed. With respect to the construction for achieving two states contradicting between before and after sliding of the plate 203 as described above, the detail will be described below.

First, when the plate 203 is inserted into the array holder 105 along with the capillary array 117, since the plate convex portion 207 abuts on the holder rail 208 of the array holder 105 as illustrated in FIG. 7A, movement of the plate 203 to the back side is restricted. When sliding of the plate 203 is started in this state, since the plate convex portion 207 slides along the front side of the holder rail 208, movement of the plate 203 to the back side is restricted. That is to say, since such state is kept that the detection unit 116 of the capillary array 117 supported by the plate 203 departs from the inner surface of the array holder 105, contamination and damage of the detection unit 116 are prevented.

When the plate convex portion 207 slides in the left and right direction and reaches the slope portion 208a of the holder rail 208, the plate 203 moves gradually to the back side along the slope. Also, when the plate convex portion 207 passes the dead end portion of the slope portion 208a of the holder rail 208, the plate side heat conduction sheet 225 abuts on the holder side heat conduction sheet 226 to come to press each other, and the periphery of the capillary array 117 is sealed.

Also, when the plate 203 is slid with respect to the array holder 105, as illustrated in FIG. 7B, the detection unit 116 becomes of a fit state. Here, when the detection unit 116 becomes of a fit state, the center position of the detection unit 116 is to agree to the center position of the window portion 228 of the array holder 105. Also, since the stick out dimension of the holder rail 208 to the front side is shorter than the protrusion dimension of the plate convex portion 207 to the back side, the holder rail 208 is in a state of departing from the plate 203.

Also, since there is a relation that the distance (d1) between the plate convex portion 207 and the center of the detection unit 116 is longer than the distance (D1) between the slide direction dead end portion of the holder rail 208 and the center of the window portion 228 formed in the array holder 105, there occurs no event that the plate convex portion 207 comes in contact with the holder rail 208 when the detection unit 116 becomes of a fit state. Further, there is a relation that the distance (d2) between the plate convex portion 207 and the end portion on the load header 129 side of the detection unit 116 is shorter than the slide direction dead end portion of the holder rail 208 and the end portion located away from the rail (D2) of the window portion 228. Therefore, it can be allowed that the end portion on the load header 129 side of the detection unit 116 does not come in contact with the end portion located away from the rail of the window portion 228 of the array holder 105 immediately after the plate convex portion 207 passes the slope portion 208a of the holder rail 208.

When the array holder cover 227 is closed, the capillary array 117 is tightly attached to the plate side heat conduction sheet 225 and the holder side heat conduction sheet 226, and the detection unit 116 is pressed to the step 231 to be positioned at a predetermined distance.

When the capillary array 117 including the detection unit 116 is to be detached, the plate 203 is slid to the right direction of FIG. 7B. At this time, since the plate convex portion 207 is gradually pushed out to the front side along the slope portion 208a of the holder rail 208, the capillary array 117 supported by the plate 203 can be detached easily from the array holder 105. Also, since the distal end of the plate convex portion 207 has a curved surface shape, not only the plate convex portion 207 is hardly hooked to the slope portion 208a of the holder rail 208, but also scraping of the holder rail 208 can be prevented.

### Second Embodiment

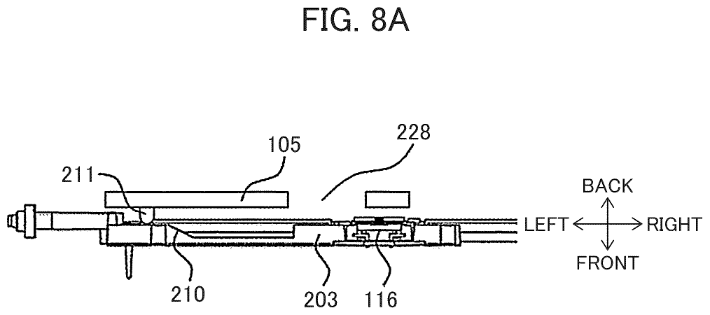

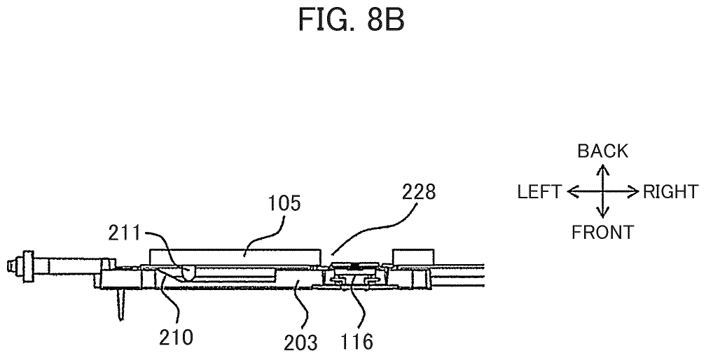

The second embodiment will be explained using FIG. 8A and FIG. 8B. FIG. 8A is a cross-sectional view illustrating the positional relation before the plate 203 is slid with respect to the array holder 105 in the second embodiment, and FIG. 8B is a cross-sectional view illustrating the positional relation after the plate 203 is slid with respect to the array holder 105 in the second embodiment. Also, FIG. 8A and FIG. 8B are those seen from a viewpoint similar to that of FIG. 7A and FIG. 7B for the first embodiment.

Although the first embodiment had a configuration that the plate 203 included a plate convex portion and the array holder 105 included a rail, the second embodiment has a configuration that the plate 203 includes a rail and the array holder 105 includes a holder convex portion 211.

First, when the plate 203 is inserted into the array holder 105 along with the capillary array 117, since a plate rail 210 abuts on the holder convex portion 211 of the array holder 105 as illustrated in FIG. 8A, movement of the plate 203 to the back side is restricted. When sliding of the plate 203 is started in this state, since the plate rail 210 slides along the front side of the holder convex portion 211, movement of the plate 203 to the back side is restricted. That is to say, since such state is kept that the detection unit 116 of the capillary array 117 supported by the plate 203 departs from the inner surface of the array holder 105, contamination and damage of the detection unit 116 are prevented.

When the plate rail 210 slides in the left and right direction and the slope located in the dead end portion of the plate rail 210 reaches the holder convex portion 211, the plate 203 moves gradually to the back side along the slope. Also, when the dead end portion of the plate rail 210 passes the holder convex portion 211 and slides further, the detection unit 116 comes to a fit state as illustrated in FIG. 8B.

When the capillary array 117 including the detection unit 116 is to be detached, the plate 203 is slid to the right direction of FIG. 8B. At this time, since the plate rail 210 is gradually pushed out to the front side along the slope of the plate rail 210, the capillary array 117 supported by the plate 203 can be detached easily from the array holder 105. Also, since the distal end of the holder convex portion 211 has a curved surface shape, not only the holder convex portion 211 is hardly hooked to the slope of the plate rail 210, but also scraping of the plate rail 210 can be prevented.

### Third Embodiment

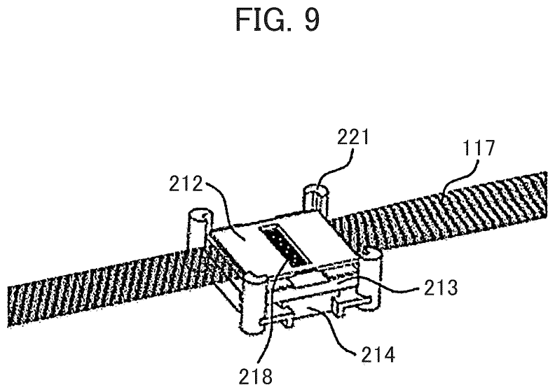

FIG. 9 is a drawing illustrating a configuration of a capillary array unit in an electrophoresis device related to the third embodiment. Unlike the first and second embodiments, the capillary array unit of the present embodiment does not include a plate that supports a part of the capillary array 117. Therefore, the non-fixed portion hangs down by the own weight of the detection unit 116 and the capillary head 112 and comes in contact with other configuration components of the electrophoresis device, and thereby the detection unit 116 is possibly contaminated and damaged.

Therefore, the base convex portion 221 in the detection unit base 214 related to the present embodiment is positioned to face the corner portion of the silicon substrate 212 and the ceramics substrate 213 as illustrated in FIG. 9, and the distance from the array surface of the capillary array 117 to the distal end of the base convex portion 221 is longer than the distance from the array surface of the capillary array 117 to the surface of the detection unit 116 (the silicon substrate 212). Therefore, the base convex portion 221 of the present embodiment also exerts a role of allowing the inner surface of the array holder 105 to depart from the detection unit 116 (particularly the silicon substrate 212) when the detection unit 116 is to be fit to the array holder 105. However, when the detection unit 116 eventually reaches the window portion 228, it is required that the detection unit 116 and the step 231 are not apart but come in contact with each other. Therefore, a hole for fitting the base convex portion 221 is arranged in the detection unit pressing surface of the slope 231, the base convex portion 221 is fit to the hole only when the detection unit 116 reaches the window portion 228, thereby the detection unit 116 is allowed to come in contact with the step 231, and the detection unit 116 is positioned at a predetermined distance with respect to the condenser lens 230. Also, since the base convex portion 221 of the present embodiment is configured to easily come in contact not only with the array holder 105 but also with other configuration components of the electrophoresis device earlier than the detection unit 116, contact with the detection unit 116 is avoided, and the silicon substrate 212 and the polyimide coating removal portion 218 can be prevented from being damaged and contaminated.

The present invention is not limited to the above-described embodiments, and further includes various modifications. For example, part of the configuration of one embodiment can be replaced with the configurations of other embodiments, and in addition, the configuration of the one embodiment can also be added with the configurations of other embodiments. In addition, part of the configuration of each of the embodiments can be subjected to addition, deletion, and replacement with respect to other configurations.

### LIST OF REFERENCE SIGNS

101: electrophoresis device, 102: capillary, 103: pump mechanism, 104: high voltage power supply, 105: array holder, 106: plunger pump, 107: block, 108: check valve, 109: polymer container, 110: positive electrode buffer container, 111: positive electrode, 112: capillary head, 113: electrically operated valve, 114: light source, 115: optical detector, 116: detection unit, 117: capillary array, 118: thermostatic chamber, 119: fan, 120: heating and cooling mechanism, 121: buffer container, 122: cleaning container, 123: waste liquid container, 124: sample container, 125: transportation mechanism, 126: hollow electrode, 127: capillary negative electrode end, 128: chamber, 129: load header, 130: moving stage, 131: grip, 201: capillary array unit, 202: frame, 203: plate, 204: separator, 205: fixing unit, 206: guide, 207: plate convex portion, 208: holder rail, 208a: slope portion, 209: wireless managing tag, 210: plate rail, 211: holder convex portion, 212: silicon substrate, 213: ceramics substrate, 214: detection unit base, 215: first window, 216: V groove, 217: second window, 218: polyimide coating removal portion, 219: measurement window, 220: recessed portion, 221: base convex portion, 222: bundle arm, 223: detection unit support portion, 224: array head support portion, 225: plate side heat conduction sheet, 226: holder side heat conduction sheet, 227: array holder cover, 228: window portion, 229: unit case, 230: condenser lens, 231: step

1. An electrophoresis device including a capillary array that includes one piece or more capillary, the capillary array including a load header arranged at one end, a capillary head arranged at the other end, and a detection unit formed between the load header and the capillary head and detecting a sample electrophoresed within the capillary, the electrophoresis device comprising:
a holder to which the detection unit is fit; and a protection unit protruding with respect to an array surface of the capillary array, wherein
when the detection unit is to be fit, the protection unit allows an inner surface of the holder to depart from the detection unit.

2. The electrophoresis device according to claim 1, further comprising:
a plate that supports a part of the capillary array including the detection unit, wherein
the protection unit formed in the plate abuts on a rail formed in the holder.

3. The electrophoresis device according to claim 2, wherein
at the time of fitting the detection unit, the protection unit moves to the back side after sliding along a front side of the rail.

4. The electrophoresis device according to claim 3, wherein
a slide direction dead end portion of the rail inclines.

5. The electrophoresis device according to claim 3, wherein
a distance between the protection unit and a center of the detection unit is longer than a distance between the slide direction dead end portion of the rail and a center of a window portion formed in the holder, and
a distance between the protection unit and an end portion on the load header side of the detection unit is shorter than a distance between the slide direction dead end portion of the rail and an end portion located away from the rail of the window portion.

6. The electrophoresis device according to claim 1, further comprising:
a plate that supports a part of the capillary array including the detection unit, wherein
a protection unit formed in the holder abuts on a rail formed in the plate.

7. The electrophoresis device according to claim 1, wherein
the protection unit is positioned to face a corner portion of the detection unit, and
a distance from an array surface of the capillary array to a distal end of the protection unit is longer than a distance from the array surface of the capillary array to a surface of the detection unit.
